(19) United States
(12) Patent Application Publication
(10) Pub. No.: US 2025/0116305 A1
(43) Pub. Date: Apr. 10, 2025

(54) BRAKE ELEMENT CARRIER BODY; BRAKE DISK OR BRAKE DRUM; METHOD FOR PRODUCING A BRAKE ELEMENT CARRIER BODY

(71) Applicant: GOTEC Brake Disc Coatings GmbH, Wulfrath (DE)

(72) Inventors: Julia FORNASIER, Anguillara Sabazia RM (IT); Thomas WAHL, Korb (DE); Thomas WEBER, Herzogenrath (DE)

(21) Appl. No.: 18/730,638

(22) PCT Filed: Jan. 23, 2023
(86) PCT No.: PCT/DE2023/100049

§ 371 Date: Jul. 19, 2024

(30) Foreign Application Priority Data
Jan. 21, 2022 (DE) 10 2022 000 215.9

(51) Int. Cl. F16D 65/12; B24C 1/08; C22C 21/02; C23C 4/02; C23C 4/06; C23C 4/129; C23C 4/18; F16D 55/22; F16D 65/02; F16D 65/04; F16D 65/095; F16D 65/10

(52) U.S. Cl. CPC F16D 65/125; B24C 1/08; C22C 21/02; C23C 4/02; C23C 4/06; C23C 4/129; C23C 4/185; F16D 65/04; F16D 65/095; F16D 65/10; F16D 65/127; F16D 65/128; F16D 55/22; F16D 2065/132; F16D 2065/1328; F16D 2200/0013; F16D 2200/0021; F16D 2200/003; F16D 2200/0052; F16D 2200/0056; F16D 2200/006; F16D 2250/0007; F16D 2250/0023; F16D 2250/0046; F16D 2250/0053; F16D 2250/0069; F16D 2250/0076

(57) ABSTRACT

A brake element carrier body with a metallic base body is claimed, wherein a surface of the base body is at least partially, preferentially completely, coated with an alloy, wherein the alloy has diffused into the base body in a diffusion zone.

The invention relates to a brake element carrier body, brake disk or brake drum; brake pad backing plate or brake shoe, a method for producing a brake element carrier body; a method for producing a brake disk or brake drum, a method for producing a brake pad backing plate or brake shoe, brake disk or brake drum; brake pad backing plate or a brake shoe; brake system.

For several decades, reducing particulate matter pollution and increasing service life to reduce waste have been a top priority in industry. In the automotive industry, the focus is no longer just on reducing exhaust emissions from internal combustion engines. Abrasion of tires and brakes is also becoming increasingly important to continue complying with the particulate matter limits.

In motor vehicles with both an electric motor and a combustion engine, more wear-resistant friction elements for brakes can contribute to this.

Brake disks for vehicles, wheel-running or rail-guided, or for industrial systems are made of metallic or ceramic materials and have several defined areas that fulfill a function. One of these areas is the friction surfaces of brake disks. To achieve the desired braking effect, brake pads work with a defined standard force on the friction surfaces. The kinetic energy applied to the friction surfaces is converted to thermal energy, i.e. heat, through sliding friction.

In conventional brake disks, the friction surfaces of the brake disks are provided with corrosion protection by painting or by superficially spraying the friction surfaces. The materials used for this usually have low tribological quality, i.e. a low friction coefficient and high wear. This works for only a short time because the friction during the braking process quickly wears off.

When the corrosion layer is removed, the base material, usually steel or gray cast iron, is fully exposed and corrosion can begin unhindered. In vehicles where traditional braking using a brake disk is seldom required, such as electric vehicles or hybrid vehicles, corrosion continues quickly after the top layer has been removed. This first leads to strongly increased wear of the friction surfaces of the brake disk. Moreover, in this condition, emergency braking cannot be performed to the required extent in an emergency due to a layer of rust that has grown and, in the worst case, the condition leads to an accident or other negative consequences.

The invention is based on the objective of providing an improvement or an alternative to the state of the art.

According to a first aspect of the invention, the objective is achieved by a brake element carrier body with a metallic base body, wherein a surface of the base body is at least partially coated with an alloy, and wherein the alloy is diffused into the base body in a diffusion zone.

In a preferential embodiment, the base body is completely coated with the alloy.

Furthermore, it is expressly pointed out that in the context of the present patent application, indefinite articles and numerical indications such as “one,” “two,” etc., are generally to be understood as “at least” specifications, i.e., as “at least one . . . ,” “at least two . . . ,” etc., unless it is implicit from the respective context or obvious to or technically imperative for the qualified expert that only “exactly one . . . ,” “exactly two . . . ,” etc., can be implied.

Diffusion is generally understood as the equalization of a concentration difference between several substances until an equilibrium is reached. Diffusion can be a thermally activated equalization process of a concentration difference in a solid, liquid or gas without external influence. In a perfect crystal lattice, each lattice particle oscillates around its fixed lattice position and cannot leave it. For diffusion in a crystalline solid, the presence of lattice defects is therefore a necessary prerequisite.

Only when these lattice defects are present can atoms or ions change places and cause a transport of material to take place. Here, various mechanisms are generally possible:
Particles jump into gaps in the lattice, causing gaps to move through the lattice, creating a net flow of particles,
Smaller particles can move in the lattice's gaps, causing a high diffusion coefficient,
two particles switch places or a ring exchange takes place among several particles.

Chemical synthesis processes are necessarily coupled to the diffusion process of the alloy into the metallic base body. This causes the intermetallic compounds responsible for improving wear resistance to be formed in the diffusion zone. The intermetallic compounds are embedded in a tougher, more ductile solid solution matrix made up of the reactants of the diffusion partners, whereby this heterogeneous solid-state combination of differently characterized components is the central prerequisite for the desired functional optimization of the brake disks.

The appearance and property profile of the solid solution matrix differ greatly from that of the metals from which it originated. The intermetallic phases are matte, intensely colored (light gray to black-gray) and leave a smooth surface when mechanically processed. Furthermore, they are stabilized by their higher lattice energy and thus have a higher melting temperature than their reactants. In addition, conductivity for heat and electrical current is reduced and they are significantly less reactive toward chemical reaction partners, i.e. toward oxidizers such as air, water, electrolytes and Brönsted acid media, and are therefore corrosion-resistant and oxidation-stable. The diffusion zone is also characterized by higher mechanical strength and increased hardness.

The alloy is preferentially completely diffused into the base body. Otherwise, alloy residues still present on the surface of the base body will be removed from the surface.

Due to the diffusion zone of the brake element carrier body, the tribological properties of the material improve and the corrosion resistance is increases.

Both corrosion protection and wear resistance can be further increased if the alloy is based on aluminum and silicon. This advantage is even more pronounced when silicon is present at 5% to 50% by mass, preferentially 10% to 40% by mass, more preferentially 15% to 30% by mass. Even in a range of 5% to 10% by mass or 7% to 15% by mass, the effect of the silicon of the alloy on the tribological properties, the low thermal expansion and increased strength and wear resistance, can be seen.

Basically, the alloy contains other alloying elements in addition to aluminum and silicon. These are primary and secondary alloying elements. The primary alloying elements are mainly elements from the second and/or third and/or fourth main group and/or the first and/or second and/or fourth and/or seventh subgroup of the Periodic Table of the Elements. For the secondary alloying elements, elements from the third and/or fourth main group and/or fourth and/or fifth and/or sixth and/or eighth subgroup of the Periodic Table of the Elements are primarily selected.

In an aluminum-based alloy having a silicon content of 5% to 50% by mass, preferentially 10% to 40% by mass, more preferentially 15% to 30% by mass, at least one primary alloying element is selected. The primary alloying elements are one or more of the following elements: Magnesium, boron, titanium, manganese, copper or zinc. These can be present in the alloy in the following areas:
Magnesium: 0.1 to 2, and/or
Boron: 0.1 to 10, and/or
Titanium: 0.1 to 5, and/or
Manganese: 0.5 to 5, and/or
Copper: 0.1 to 5, and/or
Zinc: 0.1 to 5.

For example, the elements magnesium, copper and zinc influence the hardness and cause it to increase. Meanwhile, the elements manganese and titanium have a positive effect on heat resistance and corrosion resistance.

In addition to the primary alloying elements, secondary alloying elements can also be present in the alloy. The secondary alloying elements are one or more of the following elements: Gallium, indium, germanium, tin, zirconium, vanadium, chromium, iron, cobalt or nickel. These can be present in the alloy in the following areas:
Gallium: 0.1 to 1, and/or
Indium: 0.1 to 1, and/or
Germanium: 0.1 to 1, and/or
Tin: 0.1 to 1, and/or
Zirconium: 0.1 to 1, and/or
Vanadium: 0.1 to 1, and/or
Chromium: 0.1 to 1, and/or
Iron: 0.1 to 1, and/or
Cobalt: 0.1 to 1, and/or
Nickel 0.1 to 1.

In this alloy, the remainder consists of aluminum and unavoidable impurities resulting from the manufacturing process.

Among the alloys, ternary and quaternary alloys have proven especially advantageous. These are alloys whose characteristic alloying elements include either three (ternary) or four (quaternary) substances. Only the components that determine the characteristic properties are counted. The following ternary and quaternary alloys may also contain some of the primary or secondary alloying elements already listed.

The advantageous ternary alloys are the following:
Al88 Si10 Mg2, Al88 Si10 B2, Al88 Si10 Ti2, Al88 Si10 Mn2, Al88 Si10 Cu2, Al88 Si10 Zn2, Al83 Si15 Mg2, Al83 Si15 B2, Al83 Si15 Ti2, Al83 Si15 Mn2, Al83 Si15 Cu2, Al83 Si15 Zn2, Al78 Si20 Mg2, Al78 Si20 B2, Al78 Si20 Ti2, Al78 Si20 Mn2, Al78 Si20 Cu2, Al78 Si20 Zn2.

The advantageous quaternary alloys are the following:
Al86 Si10 Mn2 Mg2, Al86 Si10 Mn2 B2, Al86 Si10 Mn2 Ti2, Al86 Si10 Mn2 Cu2, Al86 Si10 Mn2 Zn2, Al81 Si15 Mn2 Mg2, Al81 Si15 Mn2 B2, Al81 Si15 Mn2 Ti2, Al81 Si15 Mn2 Cu2, Al81 Si15 Mn2 Zn2, Al76 Si20 Mn2 Mg2, Al76 Si20 Mn2 B2, Al76 Si20 Mn2 Ti2, Al76 Si20 Mn2 Cu2, Al76 Si20 Mn2 Zn2.

Another advantageous alloy consists of 76.7% to 83.4% by mass of aluminum and 8.3% to 12.3% by mass of silicon and one or more elements selected from the list consisting of: Mg, B, Ti, Mn, Cu, Zn, Ga, Ge, Sn, Sb, Zr, V, Cr, Co, Ni and unpreventable impurities caused by the manufacturing process. The sum of all the composition's components must be 100% by weight.

A particularly advantageous aluminum-based alloy is AlSi10 with silicon content of 10% by mass, with the proportions of the primary alloying elements in the following percentage ranges by mass:
Magnesium <0.5%, and
Titanium <0.05%, and
Manganese <0.1%, and
Copper <0.005%, and
Zinc <0.005%.

The proportions of secondary alloying elements in this preferred aluminum-based AlSi10 alloy are in the following mass % ranges:
Iron <0.2%.

The mass proportion of the aluminum is then, in addition to unavoidable impurities resulting from the manufacturing conditions, the remainder, i.e. around 90% by mass. The sum of all components of the composition is 100% by mass.

Another particularly advantageous aluminum-based alloy has silicon content of 10.04% by mass, with the proportions of the primary alloying elements in the following mass percentage ranges:
Magnesium 0.31%, and
Titanium 0.02%, and
Manganese 0.01%, and
Copper 0.001%, and
Zinc 0.003%.

The proportions of secondary alloying elements in this preferred aluminum-based AlSi10 alloy are in the following mass % ranges:
Iron 0.16%.

The mass proportion of the aluminum is then, in addition to unavoidable impurities resulting from the manufacturing conditions, the remainder, i.e. around 89.456% by mass. The sum of all components of the composition is 100% by mass.

A successfully tested prototype is composed in such a way that the alloy consists of (% by mass):
Al: 76.7 to 83.4;
Si: 8.3 to 12.3
and
one or more elements selected from the list consisting of: Mg, B, Ti, Mn, Cu, Zn, Ga, Ge, Sn, Sb, Zr, V, Cr, Co, Ni, Fe and impurities
where the sum of all components of the composition must be 100% percent by weight.

In detail, the prototype was intended to have the alloy (each % by mass:
Si: 10% plus/minus 2%, preferentially plus/minus 1%;
and/or
Fe: <0.2%,
   preferentially <0.18%,
   preferentially 0.17% plus/minus 0.02 or 0.16% plus/minus 0.01%,
   in particular 0.16%;
and/or
Cu <0.005%,
   preferentially <0.003%,
   preferentially 0.0015% plus/minus 0.001%,
   in particular 0.001%;
and/or
Mg <0.5%,
   preferentially <0.4%,
   preferentially 0.35% plus/minus 0.05%, preferentially 0.31% plus/minus 0.03%
   in particular 0.31%;
and/or
Mn <0.1%
   preferentially <0.5%
   preferentially 0.01% plus/minus 0.005%
   in particular 0.01%;
and/or
Ti <0.05%
   preferentially <0.035%,
   preferentially 0.025% plus/minus 0.01%,
   in particular 0.02%;
and/or
Zn <0.005%
   preferentially <0.004%,
   preferentially 0.0035% plus/minus 0.001%,
   in particular 0.003%;
wherein preferentially at least 2, preferentially at least 3, preferentially at least 4, preferentially at least 5, preferentially at least 6, each in any possible combination,
more preferentially all seven of the aforementioned elements are present,
wherein in particular B, Ga, Ge, Sn, Sb, Zr, V, Cr, Co, Ni and/or may additionally be present, but preferentially the alloy is free of these elements,
   where the sum of all components of the composition must be 100% by mass.

Each of the aforementioned alloys individually contributes to corrosion protection and increased wear resistance. They are all characterized by high mechanical strength, which means that they all have high load-bearing capacity, pressure stability and dimensional stability.

To achieve the desired effects of increasing corrosion protection and improving wear resistance, the alloy can advantageously contain dopants. These dopants are foreign atoms that can penetrate into another solid at a sufficiently high temperature, and move and become embedded there. Here the following mechanisms can come into play:
Gap diffusion, i.e. through empty spaces in the crystal lattice,
Interstitial diffusion, i.e. between the atoms in the crystal lattice,
Place change, i.e. exchange of the lattice positions of neighboring atoms.

Diffusion with or without dopant occurs according to Fick's law. This depends on various factors, such as the material of the foreign substance and the target substance as well as their properties (crystal orientation), the concentration difference, the temperature and the concentration of other dopants in the crystal lattice. For the sake of simplicity, in this patent application only the term crystal is used in reference to the crystal lattice. How fast the diffusion takes place depends on the size of the atom and the type of diffusion in the substrate. Small diffusion coefficients usually lead to a long processing time. As already described, an important aspect for the diffusion and the resulting doping profile is the concentration difference. The doping profile mostly results from the characteristics of the dopant source. The dopant source can be an inexhaustible source or an exhaustible source. In the case of an inexhaustible dopant source, a constant dopant concentration is assumed at the surface of the crystal, so that foreign atoms diffused into the depth are replaced directly from the dopant source. This means that with increasing diffusion time and temperature, the dopant diffuses deeper into the crystal and the amount increases. The concentration at the surface remains constant. In contrast, in a diffusion from an exhaustible dopant source the amount of dopant is constant. Here, the penetration depth of the dopant increases with increasing diffusion time and temperature, but at the same time the concentration at the surface decreases.

The dopants for the alloy are selected from the third main group and/or first and/or third and/or fourth and/or fifth and/or sixth and/or seventh and/or eighth subgroup and/or the lanthanide group of the Periodic Table of the Elements.

The alloys can contain one or two dopants. In special cases, three, four or more dopants or doping agents are possible.

Preferentially, the following elements (% by mass) are used as dopants:
Antimony: 0.1 to 1, and/or
Bismuth: 0.01 to 0.1, and/or
Scandium: 0.01 to 0.1, and/or
Yttrium: 0.01 to 0.1, and/or
Lanthanum: 0.01 to 0.1, and/or
Cerium: 0.01 to 0.1, and/or
Hafnium: 0.01 to 0.1, and/or
Niobium: 0.01 to 0.1, and/or
Tantalum: 0.01 to 0.1, and/or
Molybdenum: 0.01 to 0.1, and/or
Tungsten: 0.01 to 0.1, and/or
Rhenium: 0.01 to 0.1, and/or
Ruthenium: 0.01 to 0.1, and/or
Osmium: 0.01 to 0.1, and/or
Rhodium: 0.01 to 0.1, and/or
Iridium: 0.01 to 0.1, and/or
Palladium: 0.01 to 0.1, and/or
Platinum: 0.01 to 0.1, and/or
Silver: 0.01 to 0.1, and/or
Gold: 0.01 to 0.1.

These, when added to the aforementioned alloy, lead to selective formation of desired intermetallic phases, because they act as a catalyst or inhibitor. The diffusion of the alloy and the incorporation of the dopants lead to a change in the structure. According to the proposal, the diffusion zone has a different structure compared to the carrier body. This increases the hardness and thus also the wear resistance of the brake disk carrier body.

Steel, cast steel, centrifugal casting, gray cast iron or spheroidal graphite cast iron are suitable for the base body of the brake element carrier body. An aluminum base body is also possible.

These metals are ideal for diffusing the alloys mentioned above with or without dopants. The diffusion zone created by the diffusion of the alloy into the base body has a higher hardness (in Vickers) than the material of the base body. This forms the basis for improved wear behavior.

To create a diffusion zone with adequate hardness, it is advantageous if the alloy layer has a thickness of 0.1 mm to 0.4 mm. An alloy layer thickness of 0.2 mm to 0.3 mm has proven to be particularly advantageous.

Particularly good wear resistance, i.e. hardness, and the associated good corrosion protection is achieved when the diffusion zone has a thickness of 0.05 mm to 0.6 mm. The desired properties are particularly pronounced in a range of 0.2 mm to 0.3 mm thickness of the diffusion zone.

The increased hardness is due to diffusion into the diffusion zone of the brake element carrier body. This has a medium hardness. The average hardness of the diffusion zone is increased by a factor of 1.0 to 8, preferentially 1.5 to 5, compared to the average hardness of the carrier body.

The improvement, i.e. the increase in hardness compared to the base body, depends on the base material. Accordingly, the average hardness of the diffusion zone in the case of the carrier material gray cast iron or centrifugal casting or steel or cast steel of the carrier body has a hardness increased by a factor of 2.5 to 8, in particular 2 to 5, compared to the average hardness of the carrier body. In the case of the aluminum carrier material of the carrier body, the average hardness of the diffusion zone has a hardness in HV that is increased by a factor of 1.5 to 4, in particular 1.5 to 3, compared to the average hardness of the carrier body.

The hardness distribution along the longitudinal axis, transverse axis and vertical axis or along the radius and the angular coordinate of the diffusion zone can have a maximum deviation of 10% to 15% from the average hardness (hardness in HV) of the diffusion zone.

The structure of the diffusion zone, which is different from that of the base body, has a solid solution matrix. The solid solution matrix is formed from binary or ternary or higher intermetallic phases.

A solid solution (Mc) is a crystal or crystallite that consists of at least two different chemical elements, with the foreign atoms or ions being statistically distributed.

These can either be embedded in the interstitial sites (intercalated solid solution or interstitial solution) or replace an atom of the other element by substitution (substitutional solid solution). If solid solutions have metallic properties, they are also called alloys (Wikipedia).

An intermetallic compound (also intermetallic phase or intermediate phase) is a homogeneous chemical compound of two or more metals. In contrast to alloys, they exhibit lattice structures that differ from those of the constituent metals.

Here, the solid solution matrix of the diffusion zone is present without precipitation of pure metals.

By means of the aforementioned diffusion of an alloy, in particular an alloy with dopants, into the base body of the brake element carrier body, the proposed diffusion zone can be realized in a targeted and purpose-oriented manner in the sense of a functional layer. This creates a graded layer system with almost parallel boundaries between the various phases within this layer.

The intermetallic phases of the proposed braking element carrier element have a gradually increasing concentration of iron or carbon and a gradually decreasing concentration of aluminum and/or silicon and/or the dopants as the distance from the surface of the base body increases.

In other words, the diffusion zone has a graded structure of binary, ternary or higher intermetallic phases of discrete, precisely defined daltonide chemical composition with different proportions of the original base body elements iron and carbon as well as with different proportions of the layer elements aluminum, silicon, various alloying elements and dopants introduced into the base body by diffusion.

The solid solution matrix is characterized by increased toughness and ductility compared to the intermetallic phases embedded in the solid solution matrix.

The diffused alloy with and without dopants causes the diffusion zone to have a higher melting point and/or poorer, lower thermal conductivity and/or poorer, lower electrical conductivity and/or higher mechanical strength and/or higher hardness and/or lower reactivity toward chemical reactants than the metal of the base body.

It should be expressly stated again at this point that the desired effects, i.e. the improvement of wear resistance and corrosion protection, are achieved due to the intermetallic phases that form during the diffusion of the alloy, in particular an alloy with dopants, as an integral part of the overall structure of the diffusion zone of the base body. Even though these intermetallic phases originate from metals, they themselves exhibit ceramic properties. These are due to the changed bonding conditions in the electron field of the crystal lattice, whereby the intermetallic compounds have defined valences from localized electron pairs. This makes the attack of Brönsted acid media more difficult and leads to the desired high corrosion resistance.

According to a second aspect of the invention, the objective is achieved by a brake disk or a brake drum with a brake element carrier body, with an area designed as a friction surface and with an area designed as a contact surface. In a further embodiment, the brake element carrier body used here can be designed as already described above. A brake disk with two opposing friction surfaces is particularly advantageous.

Such a brake disk or brake drum offers more effective long-term corrosion protection and increased wear resistance.

Both the friction surface and the contact surface form functional areas of the brake disk or brake drum. The friction surface is the surface on which the brake pads act with a defined normal force, whereby the desired braking effect is achieved through the sliding friction between the two. The contact surface is the surface that extends at least partially in the radial direction. It is oriented in the circumferential direction of the brake disk, whereby a normal vector also acts in the circumferential direction. This allows brake torque transfer. The contact surface can be found, for example, on the brake chamber of a brake disk.

It is proposed that the alloy layer thickness on the brake disk or brake drum is 0.1 mm to 0.4 mm. A particularly good diffusion result is achieved when the alloy layer is 0.2 mm to 0.3 mm thick.

Particularly hard, wear-resistant brake disks or brake drums are proposed to have a diffusion zone with a thickness of 0.05 mm to 0.6 mm, preferably 0.3 mm to 0.6 mm.

During braking, the friction surfaces are particularly affected. For this reason, it is possible that both the applied alloy layer thickness and the resulting diffusion zone have different thicknesses on the friction surface and the contact surface. It is particularly advantageous if the diffusion zone of the friction surface has a thickness of 0.3 mm to 0.6 mm.

For a desired braking process, it is particularly advantageous if the friction surface and the contact surface are circular. However, it is also conceivable that only one of the two surfaces is circular.

Heat can be generated due to friction during the braking process. If the temperatures generated become too high, this can have negative consequences for the service life of the brake disk or brake drum, but also for the braking process itself. For this reason, it is proposed that ventilation channels be provided to achieve an internally ventilated brake disk, for example. These can be provided on and in, but also on or in, the base body.

According to a third aspect of the invention, the objective is achieved by a brake pad backing plate or a brake shoe comprising a brake element carrier plate. Here too, in a special case, a brake element carrier plate can be provided as described above.

To achieve an optimal result in diffusion, it is advantageous if the thickness of the alloy layer on the brake pad backing plate or the brake shoe has a thickness of 0.1 mm to 0.3 mm, preferentially 0.1 mm to 0.2 mm.

Increased hardness and wear resistance is achieved when the thickness of the diffusion zone in the brake pad backing plate or brake shoe is 0.05 mm to 0.3 mm. A range of diffusion zone thickness between 0.05 mm and 0.15 mm has proven to be particularly advantageous.

To be able to perform a braking operation during use, it is proposed that a brake pad be applied to the outer surface of the alloy.

According to a fourth aspect of the invention, the objective is achieved by a method for producing a brake element carrier body, comprising the following steps:
1. Providing a base body,
2. Performing a blasting process with hard ceramic materials to remove the oxide layer on the surface of the base body,
3. Applying an aluminum-based alloy to the carrier body,
4. Tempering the carrier body with the applied alloy.

This method can be used in particular to produce the brake element carrier body described above.

The carrier body provided for the brake element carrier body can be cast or punched out.

The blasting process is especially important. This removes iron oxides from the surface of the brake disk to be coated. If these are not removed, they can act as a barrier against the inward diffusion of the elements of the applied alloy into the structure of the metallic base body.

Particularly good diffusion results in terms of production time, i.e. rapid diffusion, and quality or depth of diffusion are achieved when the base body is heated before the blasting process.

Materials with a low affinity for embedding in the material of the base body are particularly suitable for the blasting process. Hard ceramic materials are used. Corundum, quartz, boron carbide, titanium carbide, silicon carbide and chromium carbide have proven to be particularly suitable. These can be used individually or in combination for the blasting process.

The blasting process not only has the task of removing unwanted elements from the surface of the base body, but also prepares it for subsequent application of the alloy. This should diffuse quickly and easily into the structure of the metallic base body. This is advantageously achieved if the blasting process produces a roughness Rz of 5 μm to 10 μm on a surface of the base body. The roughness causes an intensive micro-form-locking bond between the applied alloy layer and the base material.

For the blasting process with hard ceramic materials, a grain size of 0.5 mm to 1.5 mm, especially 0.8 mm to 1.2 mm, has proven to be particularly effective for creating roughness.

It has proven to be very effective and efficient if the blasting process is done at an angle to the surface of the brake element carrier body, with the angle being 450±100.

In Step 3 of the process, according to the invention, an aluminum-based alloy is applied to the carrier body. The alloy is based on aluminum and silicon and may, but does not have to contain dopants. Both the alloy and the dopants have already been described in detail above in their diversity. At this point, reference is made to the above.

According to the invention, it is intended that alloying is done by means of a high-velocity flame spraying process, or an arc wire spraying process or a powder coating process.

In high-velocity flame spraying (HVOF), gas is continuously burned under high pressure within a combustion chamber, into the central axis of which the powdered spray additive is fed. With HVOF, it is advantageous to have a high flow velocity in the gas jet; this is achieved by the high pressure of the fuel gas/oxygen mixture generated in the combustion chamber and the expansion nozzle usually arranged downstream. This accelerates the spray particles to high particle velocities, which result in extremely dense spray layers with excellent adhesion properties. Propane, propene, ethylene, acetylene and hydrogen can be used as fuel gases.

In arc wire spraying, two wire-shaped spray additives made of the same or different materials are melted in an arc and spun onto the prepared workpiece surface using an atomizing gas, e.g. compressed air.

In powder coating, a powder is sprayed onto a material that is usually electrically conductive and then tempered. The powder melts on the metal surface and forms a uniform layer that protects against corrosion, for example.

It is particularly useful to apply the alloy to the base body directly after blasting, because this reduces the risk of iron oxides forming again or being deposited on the surface of the base body.

Step 4 involves tempering the carrier body with the applied alloy. This accelerates the diffusion process and allows incorporation of the dopants into the lattice structure to be controlled.

The thermal treatment, also called the tempering process, of the coated brake disk causes the inward diffusion of the alloying elements of the layer sprayed onto the surface of the base body. During a tempering process, a product is exposed to certain temperatures T over a period of time t to generate, accelerate or facilitate certain processes, e.g. chemical processes. At temperatures below the melting point of the respective sprayed layer, this inward diffusion occurs very slowly, but above the melting point it occurs much faster. The range from +590° C. to +750° C. has proven to be a functionally and economically suitable interval for the maximum holding temperature. The described tempering process or the tempering of the base body with applied alloy can be done along a temperature curve from 600° C. to 750° C. This temperature curve can be linear, exponential or cyclical. The temperature curve can also have a heating phase, a holding phase and a cooling phase.

At the beginning of the tempering process, the maximum concentration gradient between the material systems is still present as the driving gradient of the diffusion. For rapid diffusion at the beginning, a temperature of the molten layer that is only slightly above its melting point is sufficient. As diffusion progresses, the driving concentration gradient flattens out, so that to maintain rapid diffusion, the level of the holding temperature is raised continuously or in steps to compensate for the decreasing influence of the gradient by means of higher thermal kinetics. It is therefore possible to adapt the temperature curve to a concentration gradient of the diffusion of the alloy into the metal of the base body.

The reason for the adjusted holding temperature is to minimize the thermal impact collective on the structure of the metallic base body and to protect it during its thermal treatment. During melting of the sprayed layer for the purpose of its rapid inward diffusion into the base body, the melt forms an effective barrier against the oxygen in the air, which is captured on the air-facing surface of the melt and chemically bound there as aluminum oxide. The oxide layer formed prevents further oxygen from entering the melt. Therefore, no oxygen from the air can be stored in the diffusion layer during tempering. Due to the high electropositivity of aluminum and its position within the chemical series, it binds oxygen more preferentially than silicon.

For an improved result, i.e. a hard and wear-resistant diffusion zone, i.e. an alloy that has completely, at least essentially completely diffused into the base body, it is intended according to the invention that the tempering is done for 180 to 360 minutes, preferably 210 to 300 minutes.

According to a fifth aspect of the invention, the objective is achieved by a method for producing a brake disk or brake drum that comprises the following steps:
1. Providing a brake element carrier body
2. Removal of the alloy until the diffusion zone is reached, in order to create a friction surface.

The process can be used to produce the brake disk or brake drum described above. The brake element carrier body provided in Step 1 can be the brake element carrier body described above or the brake element carrier body produced according to the above method. Therefore, at this point, reference is made to the above.

To produce a clean, braking-ready friction surface, the excess alloy must be removed until the diffusion zone is reached. According to the proposal, the removal can be done mechanically. In this case, it is advisable to grind or turn the alloy. By removing the excess alloys, the friction surface or surfaces of the brake disk are formed. The friction surface has the properties of the solid solution matrix of the diffusion zone, i.e. it is very hard and wear-resistant.

Removal depends on the materials and the alloy layer thickness. However, removing the alloy up to a maximum of 0.05 mm or up to a maximum of 1 mm or up to a maximum of 1.5 mm has proven advantageous. Removal can be done in one or more steps to allow assessment of the surface from time to time.

Furthermore, the brake disk or the brake drum can have a metallic base body with a diffusion zone consisting of the matrix materials iron and carbon as well as the previously sprayed-on primary layer materials aluminum, silicon, magnesium and manganese, which has arisen as a result of a thermal treatment and inward diffusion of the layer materials, wherein the one layer thickness of the diffusion zone has a thickness of 0.05 mm to 0.6 mm, preferentially 0.3 mm to 0.6 mm.

In this case, the diffusion zone contains the elements iron, carbon, aluminum, silicon, magnesium and manganese, whereby the elements iron, aluminum, silicon and manganese form new binary, ternary and quaternary intermetallic phases in the form of many self-sufficient and separately grown crystals, which are embedded in a likewise new parallel coexisting solid solution matrix consisting of the six elements mentioned above.

Furthermore, the resulting diffusion layer can be designed in such a way that in the newly formed solid solution matrix the elements of the base body iron and carbon continuously increase with increasing depth, while the elements of the sprayed layer aluminum, silicon, magnesium and manganese continuously decrease with increasing depth. In the crystals of the newly formed intermetallic phases, the above-mentioned elements also experience changes in their concentrations with increasing depth, which qualitatively follow the same tendency, but not continuously, but in discrete jumps according to the composition formula of the respective dominant intermetallic phases.

According to a sixth aspect of the invention, the objective is achieved by a method for producing a brake pad backing plate or brake drum that comprises the following steps:
1. Providing a brake element carrier body
2. Applying a brake pad to the alloy surface to create a friction surface or contact surface.

The process can be used to produce the brake pad backing plate or brake shoe described above. The brake element carrier body provided in Step 1 can be the brake element carrier body described above or the brake element carrier body produced according to the above method. Therefore, at this point, reference is made to the above.

The brake pad applied in Step 2 can be glued or welded onto the alloyed surface of the brake element carrier body. It is thereby conceivable that the brake pad be glued and welded on.

The brake pad can be constructed as follows:
30% to 65% metal (steel, iron or brass) mixed with graphite, fillers and binders, or
10% to 30% metal (copper or steel), fibers made of glass, rubber, carbon or aramids, which can provide better braking performance at high speeds, or
Organic or mineral fibers and temperature-resistant synthetic or natural resins, which reduce brake pad wear and produce less visible dust, or
Ceramic fibers, fillers and binders, e.g. carbon fiber reinforced silicon carbide, which can reduce the volume, or
Sintered metal powder, which provides longer service life and improved heat resistance, which reduces the loss of braking effect during intensive use, or
A low proportion of metals and higher proportion of organic or mineral fibers, which results in quieter operation and less wear.

According to a seventh aspect of the invention, the objective is achieved by a brake system comprising a brake disk or brake drum as described above and a brake pad backing plate or a brake shoe as described above.

A disk brake consists of a brake disk and a brake pad backing plate. A brake drum and a brake shoe are among the necessary parts of a drum brake.

According to further aspects of the invention, the objective is achieved by a motor vehicle, a rail vehicle, a stationary industrial braking system or a wind turbine comprising this braking system.

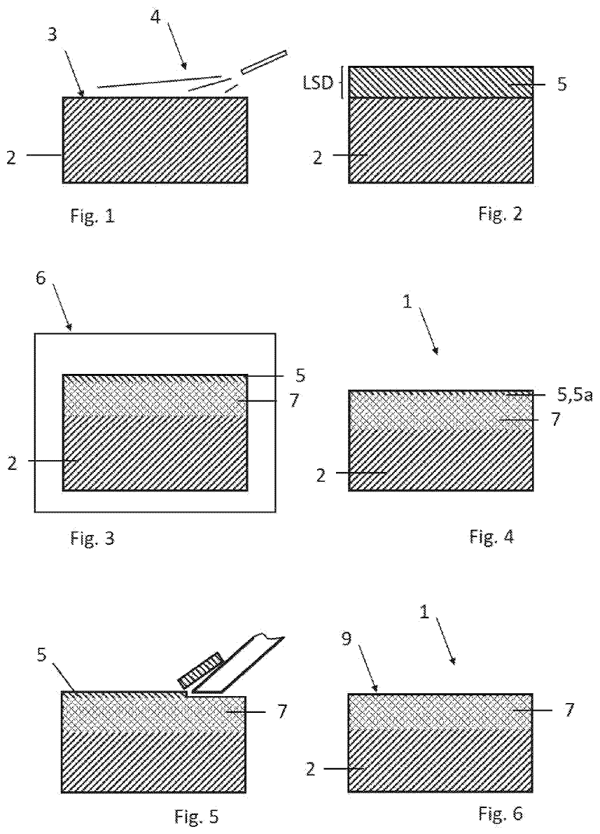

FIG. 1 Cross-section of a brake element carrier body for a brake disk or brake drum or for a brake pad backing plate or brake shoe during the blasting process;

FIG. 2 Cross-section of a brake element carrier body for a brake disk or brake drum or for a brake pad backing plate or brake shoe with applied alloy;

FIG. 3 Cross-section of a brake element carrier body for a brake disk or brake drum or for a brake pad backing plate or brake shoe during the tempering process;

FIG. 4 Cross-section of a brake element carrier body for a brake disk or brake drum or for a brake pad backing plate or brake shoe after the tempering process;

FIG. 5 Cross-section of a brake element carrier body for a brake disk or brake drum during removal of the excess alloy;

FIG. 6 Cross-section of a brake disk or brake drum;

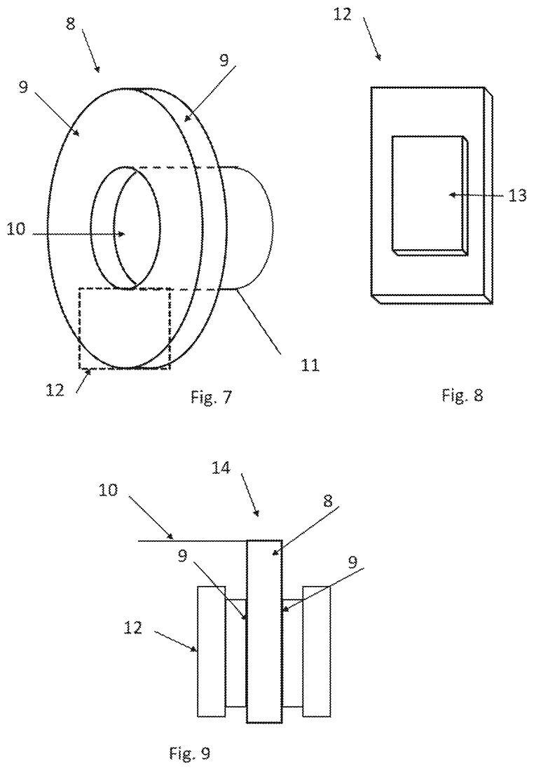

FIG. 7 Schematic representation of a brake disk with brake chamber;

FIG. 8 Schematic representation of a brake pad backing plate;

FIG. 9 Detail of a brake system comprising a brake disk and a brake pad backing plate.

FIGS. 1 to 5 show a method for producing a brake element carrier body for a brake disk or brake drum or for a brake pad backing plate or brake shoe. The claimed brake element carrier bodies for a brake disk or brake drum or for a brake pad backing plate are described in the course of the following figure description.

During production of brake element carrier body 1 for a brake disk or brake drum or for a brake pad backing plate or brake shoe, base body 2 is provided. This is made of one metal. In this case, base body 2 is made of gray cast iron. In other embodiments, base body 2 is made of steel, cast steel, centrifugal casting or spheroidal graphite cast iron.

To obtain a clean and oxide-free, especially iron oxide-free, surface, a blasting process with hard ceramic materials 4 must be performed to remove these oxide layers on surface 3 of base body 2 (FIG. 1). In this execution example, surface 3 of base body 2 is blasted with corundum with a grain size of 0.5 mm to 1.5 mm, whereby a desired roughness of 5 μm to 10 μm is produced. The blasting process is done at an angle of about 40°. Angles between 35° and 55° are especially suitable for the blasting process.

In other execution examples, quartz, boron carbide, titanium carbide, silicon carbide or chromium carbide are used to remove these oxide layers. A mixture of hard ceramic materials is also possible. Here, care should be only taken to ensure that the substances used have no affinity to diffuse into the base body.

Before this process, the base body can be heated. This improves removal of the oxide layers.

After the blasting process, the aluminum-based alloy 5 is applied to the base body. FIG. 2 shows the condition after application of the alloy 5 to the surface 3 of the base body 2. The alloys 5 can be applied as one layer or multiple layers. In the execution example, the alloy layer thickness (ALT) has been applied with a thickness of 0.25 mm. In general, the desired effect occurs with an alloy layer thickness of 0.1 mm to 0.4 mm, preferentially 0.2 mm to 0.3 mm.

For aluminum-based alloys, the combination with silicon has proven particularly advantageous for wear resistance. Silicon should be present at 5% to 50% by mass. Alloys with aluminum content between 70% and 90% by mass and a silicon content between 5% and 25% by mass have proven particularly advantageous. In the first execution example, the alloy Al88 Si10 Mg2 with antimony as dopant was applied. This was applied here using the high-velocity flame spraying process.

The following Table 1 shows further preferential aluminum-silicon alloys and Table 2 shows possible dopants.

TABLE 1
Aluminum-silicon alloys
Aluminum-silicon alloys

| | |
|---|---|
| 1 | Al88 Si10 Mg2, |
| 2 | Al88 Si10 B2, |
| 3 | Al88 Si10 Ti2, |
| 4 | Al88 Si10 Mn2, |
| 5 | Al88 Si10 Cu2, |
| 6 | Al88 Si10 Zn2, |
| 7 | Al83 Si15 Mg2, |
| 8 | Al83 Si15 B2, |
| 9 | Al83 Si15 Ti2, |
| 10 | Al83 Si15 Mn2, |
| 11 | Al83 Si15 Cu2, |
| 12 | Al83 Si15 Zn2, |
| 13 | Al78 Si20 Mg2, |
| 14 | Al78 Si20 B2, |
| 15 | Al78 Si20 Ti2, |
| 16 | Al78 Si20 Mn2, |
| 17 | Al78 Si20 Cu2, |
| 18 | Al78 Si20 Zn2, |
| 19 | Al86 Si10 Mn2 Mg2, |
| 20 | Al86 Si10 Mn2 B2, |
| 21 | Al86 Si10 Mn2 Ti2, |
| 22 | Al86 Si10 Mn2 Cu2, |
| 23 | Al86 Si10 Mn2 Zn2, |
| 24 | Al81 Si15 Mn2 Mg2, |
| 25 | Al81 Si15 Mn2 B2, |
| 26 | Al81 Si15 Mn2 Ti2, |
| 27 | Al81 Si15 Mn2 Cu2, |
| 28 | Al81 Si15 Mn2 Zn2, |
| 29 | Al76 Si20 Mn2 Mg2, |
| 30 | Al76 Si20 Mn2 B2, |
| 31 | Al76 Si20 Mn2 Ti2, |
| 32 | Al76 Si20 Mn2 Cu2, |
| 33 | Al76 Si20 Mn2 Zn2 |

TABLE 2
Dopants
Dopants

| | |
|---|---|
| a) | Antimony, |
| b) | Bismuth, |
| c) | Scandium, |
| d) | Yttrium, |
| e) | Lanthanum, |
| f) | Cerium, |
| g) | Hafnium, |
| h) | Niobium, |
| i) | Tantalum, |
| j) | Molybdenum, |
| k) | Tungsten, |
| l) | Rhenium, |
| m) | Ruthenium, |
| n) | Osmium, |
| o) | Rhodium, |
| p) | Iridium, |
| q) | Palladium, |
| r) | Platinum, |
| s) | Silver, |
| t) | Gold |

In further execution examples, one of the aluminum-silicon alloys No. 1 to No. 33 can be combined with one or more of the dopants a) to t). These increase corrosion protection and wear resistance as the dopants are incorporated with the alloy into the crystal lattice of the base body 1.

Then the diffusion process can begin. The alloy 5 diffuses into the base body 2.

Following application, the carrier body with the applied alloy is tempered. Tempering is done in a tempering oven 6. Temperatures range between 590° C. and 750° C., here with a temperature curve over a period of 270 minutes. The temperature curve has a heating phase, a holding phase and a cooling phase. During the heating phase, the carrier body with alloy is heated linearly from 590° C. to 750° C. over a period of approximately 60 minutes, held at 750° C. for 150 minutes in the holding phase, and cooled from 750° C. to 590° C. for 60 minutes in the cooling phase. However, a cycle can also be run here. The duration of the tempering process can vary. The best results were seen in all execution examples with tempering times between 180 min. and 360 min., with the best results being seen at 210 min. to 300 min. After that, no improvement could be observed from a longer tempering process.

Tempering activates the equalization process of the concentration differences between base body 2 and alloy 5. The atoms and ions of the alloy and dopants settle in the lattice defects of the crystal lattice of the base body and are deposited there. This process forms diffusion zone 7, which consists of a solid solution matrix with intermetallic phases.

In the present example, a diffusion zone with a thickness of 0.2 mm to 0.3 mm has been established. Good results are achieved at 0.05 mm to 0.6 mm. During the tempering process, the alloy diffuses completely or almost completely. In the execution example, the alloy has not completely diffused, which means that a residue of the alloy remains (FIG. 4).

This is not problematic for the brake element carrier body. It is even positive for storage of the brake element carrier body.

Starting from the final result of production of the brake element carrier body 1, as shown in FIG. 4, a brake pad backing plate 12 or brake shoe can now be produced. This is not shown here. A brake pad 13 made of sintered metal is applied, in this case glued on. It is possible to apply a smaller alloy layer thickness ALT to a brake element carrier body for a brake pad backing plate 12 or a brake shoe. For this application range, layer thicknesses of 0.1 mm to 0.3 mm are suitable, resulting in a diffusion zone 7 with a layer thickness of 0.05 mm to 0.3 mm, preferentially 0.05 mm to 0.15 mm.

To produce the brake disk or brake drum, the brake element carrier body is provided as described and manufactured according to FIG. 1 to FIG. 4. A finished brake disk 8 or brake drum requires a friction surface 9 and a contact surface 10 for braking. To produce this, the excess alloy 5 (FIG. 4) is removed from the brake element carrier body 1. According to FIG. 5, the excess alloy 5a is mechanically removed, i.e. ground or turned, to expose the diffusion zone 7, so that a finished brake disk or brake drum is produced as shown in FIG. 7, the cross-section of which is shown in FIG. 6. This is especially necessary for the braking function, because otherwise the pressed brake pads will be damaged, which in turn will have a negative effect on the service life of both parts of the braking system.

The brake disk 8 (FIG. 7) consists of a brake element carrier body 1, which was manufactured according to FIG. 1 to FIG. 4, and has a friction surface 9 and a contact surface 10. The friction surface 9 was formed by removing the excess alloy 5a down to the diffusion zone 7. To transmit torque, the brake disk has the brake chamber 11 with the contact surface 10.

The brake pad backing plate 12 (FIG. 8) comprises a brake element carrier body 1, which was manufactured as in FIGS. 1 to 4, and the brake pad 13, wherein the brake pad 13 is glued on in this execution example. In the execution example shown, a brake pad 12 made of sintered metal powder is applied.

The brake system 14 (FIG. 9) comprises a brake disk 8 and a brake pad backing plate 12. The brake system shows the braking process, i.e. when the brake pad 13 of the brake pad backing plate 12 is pressed with normal force onto the friction surfaces 9 of the brake disk. Pressure is applied through hydraulic pistons.

The brake system can be used in motor vehicles, rail vehicles, wind turbines or stationary industrial braking systems, for example.

### LIST OF REFERENCE SYMBOLS USED

1 Brake element carrier body
2 Base body
3 Surface
4 Hard ceramic materials
5 Aluminum-based alloy
5a Excess alloy
6 Tempering oven
7 Diffusion zone
8 Brake disk
9 Friction surface
10 Application surface
11 Brake chamber
12 Brake pad backing plate
13 Brake pad
14 Brake system
ALT Alloy layer thickness

1-82.

83. Brake element carrier body
with a metal base body,
whereby a surface of the base body is at least partially, preferentially completely, coated with an alloy, and
whereby in a diffusion zone, the alloy is diffused into the base body.

84. A brake element carrier body according to claim 83 characterized in that the alloy is an alloy based on aluminum and silicon.

85. A brake element carrier body according to claim 83, characterized in that the alloy has a value range of 5% (lower limit) to 50% (upper limit) of silicon by mass,
whereby the lower limit can be defined in particular as 6%, 7%, 8%, 9% or 10% silicon by mass,
and
wherein the upper limit can be defined in particular as 40%, 30%, 20%, 15%, 14%, 13%, 12%, 11% or 10% silicon by mass,
whereby the value range can be preferentially defined as 10% to 40%, 15% to 30%, 10% plus/minus 5%, 10% plus/minus 4%, 10% plus/minus 3%, 10% plus/minus 2% or 10% plus/minus 1% silicon by mass.

86. Brake element carrier body according to claim 83, characterized in that the alloy contains silicon in a value range by mass from 9% as the lower limit to 11% as the upper limit.

87. A brake element carrier body according to claim 83, characterized in that
the alloy is an aluminum- and silicon-based alloy with primary alloying elements,
wherein the primary alloying elements are selected from the second and/or third and/or fourth main group and/or the first and/or second and/or fourth and/or seventh subgroup of the Periodic Table of the Elements,
wherein the alloy preferentially has secondary alloying elements, wherein the secondary alloying elements are selected from the third and/or fourth main group and/or fourth and/or fifth and/or sixth and/or eighth subgroup of the Periodic Table of the Elements.

88. A brake element carrier body according to claim 83, characterized in that the alloy comprises 5% to 50% silicon by mass, and one or more primary alloying elements selected from one of the following elements (% by mass):
Magnesium: 0.1 to 2, and/or
Boron: 0.1 to 10, and/or
Titanium: 0.1 to 5, and/or
Manganese: 0.5 to 5, and/or
Copper: 0.1 to 5, and/or
Zinc: 0.1 to 5
and the rest consists of aluminum and impurities.

89. A brake element carrier body according to claim 88, characterized in that
(i) the alloy contains one or more secondary alloying elements selected from one of the following elements (% by mass):

| | |
|---|---|
| Gallium: | 0.1 to 1, and/or |
| Indium: | 0.1 to 1, and/or |
| Germanium: | 0.1 to 1, and/or |
| Tin: | 0.1 to 1, and/or |
| Zirconium: | 0.1 to 1, and/or |
| Vanadium: | 0.1 to 1, and/or |
| Chromium: | 0.1 to 1, and/or |
| Iron: | 0.1 to 1, and/or |
| Cobalt: | 0.1 to 1, and/or |
| Nickel | 0.1 to 1 |

and
(ii) that the alloy is one of the following ternary alloys:
Al88 Si10 Mg2,
Al88 Si10 B2,
Al88 Si10 Ti2,
Al88 Si10 Mn2,
Al88 Si10 Cu2,
Al88 Si10 Zn2,
Al83 Si15 Mg2,
Al83 Si15 B2,
Al83 Si15 Ti2,
Al83 Si15 Mn2,
Al83 Si15 Cu2,
Al83 Si15 Zn2,
Al78 Si20 Mg2,
Al78 Si20 B2,
Al78 Si20 Ti2,
Al78 Si20 Mn2,
Al78 Si20 Cu2,
Al78 Si20 Zn2.
and/or
(iii) the alloy is one of the following quaternary alloys:
Al86 Si10 Mn2 Mg2,
Al86 Si10 Mn2 B2,
Al86 Si10 Mn2 Ti2,
Al86 Si10 Mn2 Cu2,
Al86 Si10 Mn2 Zn2,
Al81 Si15 Mn2 Mg2,
Al81 Si15 Mn2 B2,
Al81 Si15 Mn2 Ti2,
Al81 Si15 Mn2 Cu2,
Al81 Si15 Mn2 Zn2,
Al76 Si20 Mn2 Mg2,
Al76 Si20 Mn2 B2,
Al76 Si20 Mn2 Ti2,
Al76 Si20 Mn2 Cu2,
Al76 Si20 Mn2 Zn2.

90. A brake element carrier body according to claim 83, characterized in that the alloy consists of (% by mass):
Al: 76.7 to 83.4;
Si: 8.3 to 12.3
and
one or more elements selected from the list consisting of: Mg, B, Ti, Mn, Cu, Zn, Ga, Ge, Sn, Sb, Zr, V, Cr, Co, Ni, Fe and impurities
where the sum of all components of the composition must be 100% percent by weight.

91. A brake element carrier body according to claim 92, characterized in that the alloy consists of (% by mass):
Si: 10% plus/minus 2%, preferentially plus/minus 1%.
and/or
Fe: <0.2%,
preferentially <0.18%,
preferentially 0.17% plus/minus 0.02 or 0.16% plus/minus 0.01%,
in particular 0.16%;
and/or
Cu <0.005%,
preferentially <0.003%,
preferentially 0.0015% plus/minus 0.001%,
in particular 0.001%;
and/or
Mg <0.5%,
preferentially <0.4%,
preferentially 0.35% plus/minus 0.05%, preferentially 0.31% plus/minus 0.03%
in particular 0.31%;
and/or
Mn <0.1%
preferentially <0.5%
preferentially 0.01% plus/minus 0.005%
in particular 0.01%;
and/or
Ti <0.05%
preferentially <0.035%,
preferentially 0.025% plus/minus 0.01%,
in particular 0.02%;
and/or
Zn <0.005%
preferentially <0.004%,
preferentially 0.0035% plus/minus 0.001%,
in particular 0.003%;
wherein preferentially at least 2, preferentially at least 3, preferentially at least 4, preferentially at least 5, preferentially at least 6, each in any possible combination,
more preferentially all seven of the aforementioned elements are present,
wherein in particular B, Ga, Ge, Sn, Sb, Zr, V, Cr, Co, Ni and/or may additionally be present, but preferentially the alloy is free of these elements,
where the sum of all components of the composition must be 100% by mass.
and
wherein the brake element carrier body may optionally be such that the alloy contains dopants, wherein the dopants are preferentially selected from the third main group and/or first and/or third and/or fourth and/or fifth and/or sixth and/or seventh and/or eighth subgroup and/or the lanthanide group of the Periodic Table of the Elements.
and/or
wherein the brake element carrier body may optionally be such that the alloy has one or two or three or more dopants.
wherein, in the case of dopants, the dopants are selected from one or more of the following elements (% by mass):
Antimony: 0.1 to 1, and/or
Bismuth: 0.01 to 0.1, and/or
Scandium: 0.01 to 0.1, and/or
Yttrium: 0.01 to 0.1, and/or
Lanthanum: 0.01 to 0.1, and/or
Cerium: 0.01 to 0.1, and/or
Hafnium: 0.01 to 0.1, and/or
Niobium: 0.01 to 0.1, and/or
Tantalum: 0.01 to 0.1, and/or
Molybdenum: 0.01 to 0.1, and/or
Tungsten: 0.01 to 0.1, and/or
Rhenium: 0.01 to 0.1, and/or
Ruthenium: 0.01 to 0.1, and/or
Osmium: 0.01 to 0.1, and/or
Rhodium: 0.01 to 0.1, and/or
Iridium: 0.01 to 0.1, and/or
Palladium: 0.01 to 0.1, and/or
Platinum: 0.01 to 0.1, and/or
Silver: 0.01 to 0.1, and/or
Gold: 0.01 to 0.1.

92. A brake element carrier body according to claim 83, characterized in that the base body is made of steel, cast steel, centrifugal casting, gray cast iron or spheroidal graphite cast iron;
wherein preferably, the base body is made of aluminum.

93. A brake element carrier body according to claim 83, characterized in that the alloy layer thickness is 0.1 mm to 0.4 mm, preferentially 0.2 mm to 0.3 mm.

94. A brake element carrier body according to claim 83, characterized in that the diffusion zone has a thickness of 0.05 mm to 0.6 mm, preferentially 0.2 mm to 0.3 mm;
wherein, preferably, the diffusion zone has a different structure compared to the carrier body;
wherein especially, the diffusion zone might have a solid solution matrix that is formed from binary or ternary or higher intermetallic phases,
which might preferably that the solid solution matrix has a continuously increasing concentration of iron or carbon and a continuously decreasing concentration of aluminum and/or silicon and/or the dopants as the distance from the surface of the base body increases.

95. A brake element carrier body according to claim 83, characterized in that the intermetallic phases have a gradually increasing concentration of iron or carbon and a gradually decreasing concentration of aluminum and/or silicon and/or the dopants as the distance from the surface of the base body increases.

96. A brake element carrier body according to claim 94, characterized in that the solid solution matrix has an increased toughness and ductility compared to the intermetallic phases embedded in the solid solution matrix.

97. A brake element carrier body according to claim 83, characterized in that
the diffusion zone has a higher melting point and/or lower thermal conductivity and/or lower electrical conductivity and/or higher mechanical strength and/or higher hardness and/or lower reactivity to chemical reaction partners than the metal of the base body;
wherein, preferably, the diffusion zone the solid solution matrix is present without precipitation of pure metals;
and/or
the diffusion zone has a medium hardness, wherein the average hardness of the diffusion zone has a hardness increased by a factor of 1.0 to 8, preferentially 1.5 to 5, compared to the average hardness of the carrier body.

98. A brake element carrier body according to claim 83, characterized in that,
in the case of the carrier material, gray cast iron or centrifugal casting or steel or cast steel of the carrier body, the average hardness of the diffusion zone increases by a factor of 2.5 to 8, in particular 2 to 5, compared to the average hardness of the carrier body
and/or
in the case of the aluminum carrier material of the carrier body, the average hardness of the diffusion zone has a hardness in HV that is increased by a factor of 1.5 to 4, in particular 1.5 to 3, compared to the average hardness of the carrier body
and/or
that the hardness distribution along the longitudinal axis, transverse axis and vertical axis or along the radius and the angular coordinate of the diffusion zone has a maximum deviation of 10% to 15% from the average hardness (hardness in HV) of the diffusion zone.

99. A brake disk or brake drum with a brake element carrier body, in particular a brake element carrier body according to one of claim 83, with an area designed as a friction surface and with an area designed as a contact surface.
wherein ventilation channels might be intended on and/or in the base body.

100. A brake disk or brake drum according to claim 99, characterized in that the alloy layer thickness is 0.1 mm to 0.4 mm, preferentially 0.2 mm to 0.3 mm.

101. A brake disk or brake drum according to claim 99, characterized in that the diffusion zone has a thickness of 0.05 mm to 0.6 mm, preferentially 0.3 mm to 0.6 mm.

102. A brake disk or brake drum according to claim 99, characterized in that the diffusion zone of the friction surface has a thickness of 0.3 mm to 0.6 mm;
wherein, preferably, the friction surface and/or contact surface might be annular.

103. A brake disk or brake drum, comprising a metallic base body with a diffusion zone consisting of the matrix materials iron and carbon as well as the previously sprayed-on primary layer materials aluminum, silicon, magnesium and manganese, which has been created as a result of a thermal treatment and inward diffusion of the layer materials, which has a layer thickness of the diffusion zone of 0.05 mm to 0.6 mm, preferably 0.3 mm to 0.6 mm.

104. A brake disk or brake drum according to claim 103, characterized in that the diffusion zone contains the elements iron, carbon, aluminum, silicon, magnesium and manganese, wherein the elements iron, aluminum, silicon and manganese form new binary, ternary and quaternary intermetallic phases in the form of many self-sufficient and separately grown crystals, which are embedded in a likewise new parallel coexisting solid solution matrix consisting of the six above-mentioned elements.

105. A brake disk or brake drum according to claim 103, characterized in that the resulting diffusion layer is designed in such a way that in the newly formed solid solution matrix the elements of the base body, iron and carbon increase continuously with increasing depth, while the elements of the sprayed-on layer aluminum, silicon, magnesium and manganese decrease continuously with increasing depth. In the crystals of the newly formed intermetallic phases, the above-mentioned elements also experience changes in their concentrations with increasing depth, which qualitatively follow the same tendency, but not continuously, but in discrete jumps according to the composition formula of the respective dominant intermetallic phases.

106. A brake pad backing plate or brake shoe comprising a brake element carrier plate, in particular a brake element carrier plate according to claim 83:
wherein, preferably, the alloy layer thickness might be 0.1 mm to 0.3 mm, preferentially 0.1 mm to 0.2 mm,
and/or the diffusion layer thickness might be 0.05 mm to 0.3 mm, preferentially 0.05 mm to 0.15 mm,
wherein, preferably, a brake pad might be applied to the outer surface of the alloy.

107. A method for producing a brake element carrier body, in particular a brake element carrier body according to claim 83, comprising the following steps:
1. Providing a base body,
2. Performing a blasting process with hard ceramic materials to remove the oxide layer on the surface of the base body,
3. Applying an aluminum-based alloy to the carrier body,
4. Tempering the carrier body with the applied alloy.
wherein, preferably, the base body is heated before the blasting process.

108. A method according to claim 107, characterized in that the hard ceramic materials in the blasting process are corundum and/or quartz and/or boron carbide and/or titanium carbide and/or silicon carbide and/or chromium carbide.

109. A method according to claim 107, characterized in that the blasting process produces a roughness Rz of 5 μm to 10 μm on a surface of the base body.

110. A method according to claim 107, characterized in that the hard ceramic materials have a grain size of 0.5 mm to 1.5 mm, in particular 0.8 mm to 1.2 mm.

111. A method according to claim 108, characterized in that the blasting process is done at an angle to the surface of the brake element carrier body, the angle being 45°±10°.

112. A method according to claim 108, characterized in that the alloy
(i) is an aluminum- and silicon-based alloy
and/or
(ii) contains 5% to 50% silicon by mass
and/or
(iii) is an aluminum- and silicon-based alloy
with primary alloying elements,
wherein the primary alloying elements are selected from the second and/or third and/or fourth main group and/or the first and/or second and/or fourth and/or seventh subgroup of the Periodic Table of the Elements,
wherein the secondary alloying elements are selected from the third and/or fourth main group and/or fourth and/or fifth and/or sixth and/or eighth subgroup of the Periodic Table of the Elements,
wherein the alloy comprises secondary alloying elements, wherein the secondary alloying elements are selected from the third and/or fourth main group and/or fourth and/or fifth and/or sixth and/or eighth subgroup of the Periodic Table of the Elements.

113. A method according to claim 108, characterized in that the alloy consists of one or more primary alloying elements selected from one of the elements (% by mass):
Magnesium: 0.1 to 2, and/or
Boron: 0.1 to 10, and/or
Silicon: 5 to 50, and/or
Titanium: 0.1 to 5, and/or
Manganese: 0.5 to 5, and/or
Copper: 0.1 to 5, and/or
Zinc: 0.1 to 5,
and the rest consists of aluminum and unavoidable, production-related impurities.

114. A brake element carrier body according to claim 108, characterized in that the alloy contains one or more secondary alloying elements selected from one of the following elements (% by mass):
Gallium: 0.1 to 1, and/or
Indium: 0.1 to 1, and/or
Germanium: 0.1 to 1, and/or
Tin: 0.1 to 1, and/or
Zirconium: 0.1 to 1, and/or
Vanadium: 0.1 to 1, and/or
Chromium: 0.1 to 1, and/or
Iron: 0.1 to 1, and/or
Cobalt: 0.1 to 1, and/or
Nickel 0.1 to 1.

115. A method according to claim 108, characterized in that the alloy is one of the following ternary alloys:
Al88 Si10 Mg2,
Al88 Si10 B2,
Al88 Si10 Ti2,
Al88 Si10 Mn2,
Al88 Si10 Cu2,
Al88 Si10 Zn2,
Al83 Si15 Mg2,
Al83 Si15 B2,
Al83 Si15 Ti2,
Al83 Si15 Mn2,
Al83 Si15 Cu2,
Al83 Si15 Zn2,
Al78 Si20 Mg2,
Al78 Si20 B2,
Al78 Si20 Ti2,
Al78 Si20 Mn2,
Al78 Si20 Cu2,
Al78 Si20 Zn2.

116. A method according to claim 108, characterized in that the alloy is one of the following quaternary alloys:
Al86 Si10 Mn2 Mg2,
Al86 Si10 Mn2 B2,
Al86 Si10 Mn2 Ti2,
Al86 Si10 Mn2 Cu2,
Al86 Si10 Mn2 Zn2,
Al81 Si15 Mn2 Mg2,
Al81 Si15 Mn2 B2,
Al81 Si15 Mn2 Ti2,
Al81 Si15 Mn2 Cu2,
Al81 Si15 Mn2 Zn2,
Al76 Si20 Mn2 Mg2,
Al76 Si20 Mn2 B2,
Al76 Si20 Mn2 Ti2,
Al76 Si20 Mn2 Cu2,
Al76 Si20 Mn2 Zn2.

117. A method according to claim 108, characterized in that the alloy consists of (% by mass):
Al: 76.7 to 83.4;
Si: 8.3 to 12.3
and the rest consists of Mg, B, Ti, Mn, Cu, Zn, Ga, Ge, Sn, Sb, Zr, V, Cr, Co, Ni and unavoidable production-related impurities,
wherein the alloy may contain dopants,
wherein the dopants are preferably selected from the third main group and/or first and/or third and/or fourth and/or fifth and/or sixth and/or seventh and/or eighth subgroup and/or the lanthanide group of the Periodic Table of the Elements.

118. A method according to claim 108, characterized in that the alloy comprises one or two or three or more dopants, wherein the dopants consist of one of the elements (% by mass):
Antimony: 0.1 to 1, and/or
Bismuth: 0.01 to 0.1, and/or
Scandium: 0.01 to 0.1, and/or
Yttrium: 0.01 to 0.1, and/or
Lanthanum: 0.01 to 0.1, and/or
Cerium: 0.01 to 0.1, and/or
Hafnium: 0.01 to 0.1, and/or
Niobium: 0.01 to 0.1, and/or
Tantalum: 0.01 to 0.1, and/or
Molybdenum: 0.01 to 0.1, and/or
Tungsten: 0.01 to 0.1, and/or
Rhenium: 0.01 to 0.1, and/or
Ruthenium: 0.01 to 0.1, and/or
Osmium: 0.01 to 0.1, and/or
Rhodium: 0.01 to 0.1, and/or
Iridium: 0.01 to 0.1, and/or
Palladium: 0.01 to 0.1, and/or
Platinum: 0.01 to 0.1, and/or
Silver: 0.01 to 0.1, and/or
Gold: 0.01 to 0.1.

119. A method according to claim 108, characterized in that the dopants of the alloy act as selectively active catalysts and/or inhibitors.

120. A method according to claim 108, characterized in that the alloy layer thickness is 0.1 mm to 0.4 mm, preferentially 0.2 mm to 0.3 mm.

121. A method according to claim 108, characterized in that the alloying is done by means of a high-velocity flame spraying process, or an arc wire spraying process or a powder coating process.

122. A method according to claim 108, characterized in that the tempering takes place at a temperature between 590° C. (1,094 degrees Fahrenheit) and 750° C. (1,382 degrees Fahrenheit),
wherein, preferably, the tempering may take place along a temperature curve from 600° C. (1,112 degrees Fahrenheit) to 750° C. (1,382 degrees Fahrenheit), wherein the temperature curve is linear or exponential or cyclical or has a heating phase, a holding phase and a cooling phase,
wherein, preferably, the temperature curve is adapted to a concentration gradient of the diffusion of the alloy into the metal of the base body.

123. A method according to claim 108, characterized in that the tempering is done for 180 to 360 minutes, preferentially 210 to 300 minutes.

124. A method according to claim 108, characterized in that the carrier body is cast and/or punched out.

125. A method for producing a brake disk or brake drum, in particular a brake disk or brake drum according to claim 99, comprising the following steps:
a. Providing a brake element carrier body, and
b. Removal of the alloy until the diffusion zone is reached in order to create a friction surface and/or a contact surface.

126. A method according to claim 125, characterized in that the alloy
(i) is removed mechanically
and/or
(ii) is ground or turned
and/or
(iii) is removed to a maximum of 0.05 mm or to a maximum of 1 mm or to a maximum of 1.5 mm.

127. A method for producing a brake pad backing plate or brake shoe, in particular a brake pad backing plate or brake shoe according to claim 106, comprising the following steps:
a. Providing a brake element carrier body, and
b. Applying a brake pad to the alloyed surface to create a friction surface or contact surface.

128. A method according to claim 127, characterized in that the brake pad is glued and/or welded on.

129. A method according to one of claim 127, characterized in that the brake pad comprises one or more of the following materials:
Metal and/or sintered metal powder, in particular steel, iron, copper or brass, and/or
Graphite and/or
Glass and/or
Rubber and/or
Carbon and/or
Aramids and/or
Artificial resins and/or
Natural resins and/or
Ceramic fibers and/or
Binders.

130. A brake disk or brake drum manufactured by a process according to claim 43.

131. A brake pad backing plate or brake shoe manufactured according to claim 127.

132. A braking system, comprising:
a brake disk or a brake drum,
and
a brake pad backing plate or a brake shoe,
wherein the brake disk or the brake drum and the brake pad backing plate or the brake shoe are manufactured on a brake element carrier body according to claim 1.

133. A
motor vehicle or aircraft; or
rail vehicle; or
stationary industrial braking system; or
wind turbine
having a braking system according to claim 132.
